(19) United States
(12) Patent Application Publication
(10) Pub. No.: US 2015/0009215 A1
(43) Pub. Date: Jan. 8, 2015

(54) GENERATING A 3D IMAGE FOR GEOLOGICAL MODELING

(71) Applicant: SCHLUMBERGER TECHNOLOGY CORPORATION, SUGAR LAND, TX (US)

(72) Inventors: Manoj Vallikkat Thachaparambil, Kerala (IN); Zhigao Zhu, Beijing (CN); Qianxin Liu, Beijing (CN)

(73) Assignee: Schlumberger Technology Corporation, Sugar Land, TX (US)

(21) Appl. No.: 14/379,447

(22) PCT Filed: Feb. 16, 2013
(86) PCT No.: PCT/US2013/026577

§ 371 Date: Aug. 18, 2014

Related U.S. Application Data
(60) Provisional application No. 61/599,939, filed on Feb. 17, 2012.

(51) Int. Cl. G06T 17/05; G01V 99/00

(52) U.S. Cl. CPC G06T 17/05; G01V 99/005; G06T 2200/24; G06T 2219/2012
USPC 345/420

(57) ABSTRACT

Generating a 3D image for geological modeling includes receiving a two dimensional (2D) facies map of the surface of a geographic region. 2D objects are extracted from the 2D facies map and combined into an object group. The 2D object group is edited to adjust for spatial distribution in 3D space to obtain edited 2D object group. Further, a depth is assigned to the edited 2D object group to obtain a 3D object group. A facies characteristic is assigned to the 3D object group to obtain the 3D compound model, which is stored.

### BACKGROUND

Operations, such as surveying, drilling, wireline testing, completions, production, planning and field analysis, may be performed to locate and gather valuable downhole fluids. Surveys are performed using acquisition methodologies, such as seismic scanners or surveyors to obtain data about underground formations. During drilling and production operations, data may be collected for analysis and/or monitoring of the operations. Such data may include, for instance, information regarding subterranean formations, equipment, historical, and/or other data. Simulators use the data to model the location or gathering of the downhole fluids.

### SUMMARY

In general, in one aspect, embodiments of generating a 3D image for geological modeling include receiving a two dimensional (2D) facies map of the surface of a geographic region. 2D objects are extracted from the 2D facies map and combined into an object group. The 2D object group is edited to adjust for spatial distribution in 3D space to obtain edited 2D object group. Further, a depth is assigned to the edited 2D object group to obtain a 3D object group. A facies characteristic is assigned to the 3D object group to obtain the 3D compound model, which is stored.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects will be apparent from the following description and the appended claims.

### BRIEF DESCRIPTION OF DRAWINGS

Embodiments are described with reference to the following figures. The same numbers are used throughout the figures to reference like features and components.

FIGS. 1 and 2 show schematic diagrams in one or more embodiments.

FIGS. 3-5 show flowcharts in one or more embodiments.

FIGS. 6.1-6.7 show an example in one or more embodiments.

FIG. 7 shows a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that the embodiments may be practiced without these specific details. In other instances, well-known features have not been described in detail to avoid unnecessarily complicating the description.

In general, embodiments provide a method and apparatus to generate a three dimensional (3D) compound model for geological modeling from a two-dimensional (2D) facies map of the surface of a geographic region. Specifically, from the 2D facies map, 2D objects are extracted and combined into an object group. The 2D object group is edited, such as by size, rotation and other aspects, to adjust for the spatial distribution in 3D space. A depth is assigned to the edited to 2D object group. The depth provides insight as to the shape of the objects in the object group beneath the surface of the geographic region. One or more facies characteristics are assigned to the 3D object group to obtain the 3D compound model. The facies characteristics define the rock properties of the 3D object group. The 3D compound model may be used directly into a geological model or as a training image to create a geological model.

The term, “facies,” as used herein refers to the standard definition for facies as used in the field of Geology. Specifically, facies is a body of a rock with specified characteristics. More specifically, a facies is rock or other stratified body that is distinguished from other rocks or stratified bodies by facies characteristics, such as type (e.g., sedimentary, metamorphic), appearance, composition, grain size, bedding characteristics, sedimentary structures, biological (fossil) components, and/or embedded minerals. Facies may also refer to groups of rocks that may have been formed under similar conditions. In other words, facies characteristics define geological properties of the facies.

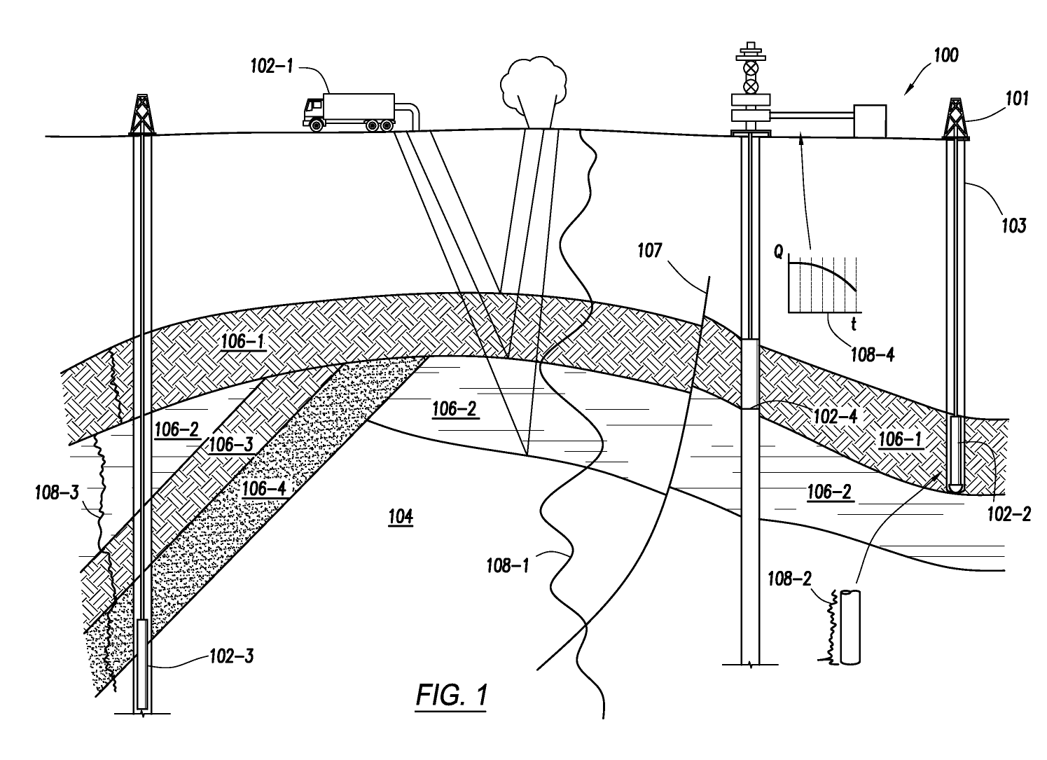

FIG. 1 shows an example of a schematic diagram of a data collection system in one or more embodiments. Specifically, FIG. 1 depicts a schematic view, partially in cross section of a field (100) having data acquisition tools (102-1), (102-2), (102-3), and (102-4) positioned at various locations in the field for gathering data of a subterranean formation (104). As shown, the data collected from the tools (102-1 through 102-4) can be used to generate data plots (108-1 through 108-4), respectively.

As shown in FIG. 1, the subterranean formation (104) includes several geological structures (106-1 through 106-4). As shown, the formation has a sandstone layer (106-1), a limestone layer (106-2), a shale layer (106-3), and a sand layer (106-4). A fault line (107) extends through the formation. In one or more embodiments, the static data acquisition tools are adapted to measure the formation and detect the characteristics of the geological structures of the formation.

As shown in FIG. 1, a drilling operation is depicted as being performed by drilling tools (102-2) suspended by a rig (101) and advanced into the subterranean formations (104) to form a wellbore (103). The drilling tools (102-2) may be adapted for measuring downhole properties using logging-while-drilling (“LWD”) tools.

A surface unit (not shown) is used to communicate with the drilling tools (102-2) and/or offsite operations. The surface unit is capable of communicating with the drilling tools (102-2) to send commands to the drilling tools (102-2), and to receive data therefrom. The surface unit may be provided with computer facilities for receiving, storing, processing, and/or analyzing data from the oilfield. The surface unit collects data generated during the drilling operation and produces data output which may be stored or transmitted. Computer facilities, such as those of the surface unit, may be positioned at various locations about the oilfield and/or at remote locations.

Sensors, such as gauges, may be positioned about the oilfield to collect data relating to various oilfield operations as described previously. For example, the sensor may be positioned in one or more locations in the drilling tools (102-2) and/or at the rig (101) to measure drilling parameters, such as weight on bit, torque on bit, pressures, temperatures, flow rates, compositions, rotary speed and/or other parameters of the oilfield operation. The sensors may also have features or capabilities, of monitors, such as cameras (not shown), to provide pictures of the operation. Surface sensors or gauges may be deployed about the surface systems to provide information about the surface unit, such as standpipe pressure, hook load, depth, surface torque, and rotary rpm, among others. Downhole sensors or gauges (i.e., sensors located within the borehole) are disposed about the drilling string and/or wellbore to provide information about downhole conditions, such as wellbore pressure, weight on bit, torque on bit, direction, inclination, collar rpm, tool temperature, annular temperature and tool face, and other such data. In one or more embodiments, additional or alternative sensors may measure properties of the formation, such as gamma rays sensors, formation resistivity sensors, formation pressure sensors, fluid sampling sensors, hole-calipers, and distance stand-off measurement sensors, and other such sensors. The sensors may continually gather data and directly or indirectly update the 3D compound model, 3D objects, and/or geological model.

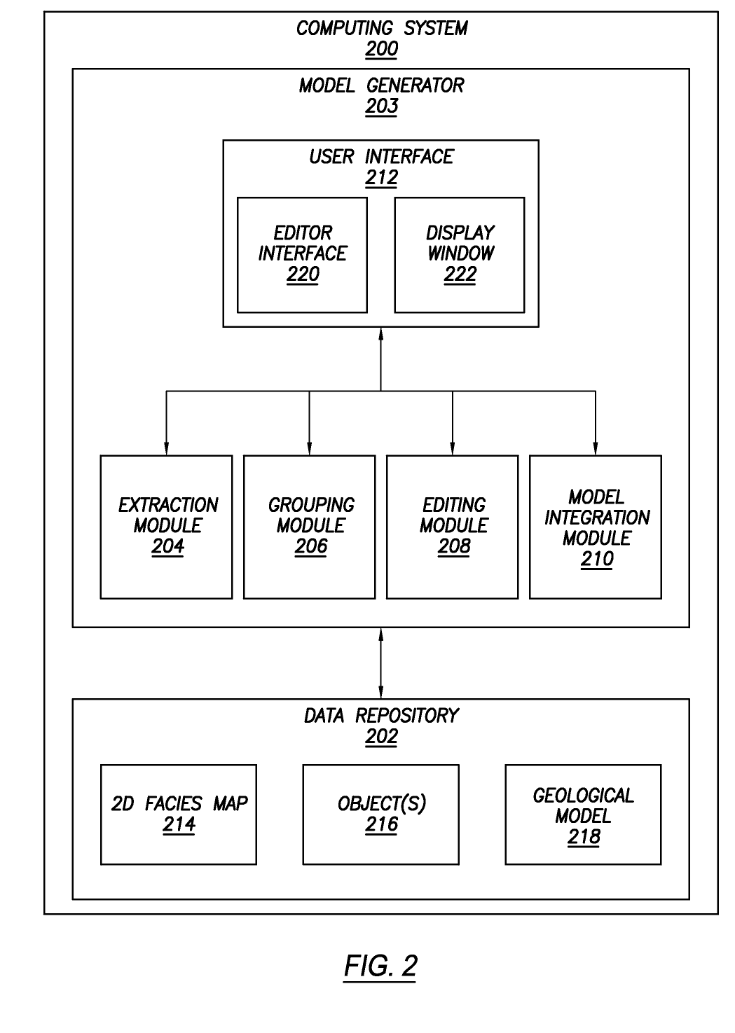

The data gathered by the sensors may be collected by one or more components of the system shown in FIG. 2. The data collected by the sensors may be used alone or in combination with other data. The data may be collected in one or more databases and/or transmitted on or offsite. At least a portion of the data may be selectively used for analyzing and/or predicting oilfield operations of the current and/or other wellbores. The data may be historical data, real time data or combinations thereof. The real time data may be used in real time, or stored for later use. The data may also be combined with historical data or other inputs for further analysis. The data may be stored in separate databases, or combined into a single database.

The collected data may be used to perform activities, such as wellbore steering. Specifically, the reservoir, wellbore, surface and/or process data may be used to perform geological simulations. The geological simulations may include simulating the surface and subsurface of a geological region that may or may not correspond to at least a portion of a reservoir. The data outputs from the oilfield operation may be generated directly from the sensors, or after some preprocessing or modeling. These data outputs may act as inputs for further analysis.

As shown in FIG. 1, data plots (108-1 through 108-4) are examples of plots of static properties that may be generated by the data acquisition tools (102-1 through 102-4), respectively. For example, data plot (108-1) is a seismic two-way response time. In another example, data plot (108-2) is core sample data measured from a core sample of the formation (104). In another example, data plot (108-3) is a logging trace. In another example, data plot (108-4) is a plot of a dynamic property, the fluid flow rate over time. In addition to the aforementioned data plots, a seismic cube may be constructed from the different types of data. Other data may also be collected, such as, but not limited to, historical data, user inputs, economic information, other measurement data, and other parameters of interest.

While a specific subterranean formation (104) with specific geological structures is depicted, it will be appreciated that the formation may contain a variety of geological structures. Fluid, rock, water, oil, gas, and other geomaterials may also be present in various portions of the formation. Each of the measurement devices may be used to measure properties of the formation and/or its underlying structures. While each acquisition tool is shown as being in specific locations along the formation, it will be appreciated that one or more types of measurement may be taken at one or more location across one or more fields or other locations for comparison and/or analysis using one or more acquisition tools. The terms measurement device, measurement tool, acquisition tool, and/or field tools are used interchangeably in this documents based on the context.

FIG. 2 shows a computing system (200) in one or more embodiments. The computing system (200) may be communicatively coupled, directly or indirectly, to one or more of the equipment (e.g., sensors, drilling tool, rig, and other components) shown in FIG. 1. Specifically, through the coupling, the computing system (200) may receive data from and send instructions to the equipment. Thus, the computing system (200) may control various aspects of the subsurface operations. As shown in FIG. 2, the computing system (200) includes a data repository (202) and a model generator (203). The computing system (200) may include additional components.

In one or more embodiments, the data repository (202) is any type of storage unit and/or device (e.g., a file system, database, collection of tables, or any other storage mechanism) for storing data. Further, the data repository (202) may include multiple different storage units and/or devices. The multiple different storage units and/or devices may or may not be of the same type or located at the same physical site. In one or more embodiments, the data repository (202) stores a 2D facies map (214), one or more objects (216), and a geological model (218). Each of these is discussed below.

A 2D facies map (214) is a stratigraphic map indicating distribution of facies within a specific geographic region. Specifically, a 2D facies map is an image of a surface of the earth corresponding to a geological region that has coloring identifying distinct facies. Specifically, the colors in the facies map define distinct geological features. For example, rivers and other waterways may be blue whereas sand or sandstone may be brown or a variation of brownish colors. Further, volcanic rock may have different coloration than sedimentary rock. The image may be a photograph or graphical representation. For example, the 2D facies map may be a satellite image, aerial photograph, a computer generated image, or other such image. In one or more embodiments, the 2D facies map may be obtained from a third party, such as the United State Geological Survey (USGS) or National Aeronautics and Space Administration (NASA). In one or more embodiments, the 2D facies map is composed of pixels. Each pixel is includes a color and a position of the pixel.

In one or more embodiments, an object (216) corresponds to a distinct geological structure in the 2D facies map. For example, an object (216) may correspond to a particular facies. An object (216) may be defined as a grouping of one or more connected pixels in the 2D facies map that share the same color and may be extracted from the facies map. Here, the use of the term, “same,” includes substantially the same. In one or more embodiments, objects (216) may be extracted from the 2D facies map and independently assigned depth and facies characteristics.

A geological model (218) is a model of at least the subsurface of a geographic region. The geological model (218) may additionally include a model of the surface of the geographic region. In one or more embodiments, the geological model (218) includes information about the lithology of the geographic region, such as geological structures and facies of the geographic region. The geological model may include models of existing and expected changes in the geographic region from drilling, production, and other operations.

Continuing with FIG. 2, a model generator (203) is hardware, software, firmware, or a combination thereof that includes functionality to generate a model from a 2D facies map. The model may be a 3D compound model or a geological model. The model generator (203) may include one or more of an extraction module (204), a grouping module (206), an editing module (208), a model integration module (210), and a user interface (212). Each of these components is discussed below.

In one or more embodiments, an extraction module (204) includes functionality to extract objects (216) from the 2D facies map. Specifically, the extraction module (204) includes functionality to receive a color or group of colors and extract objects in the 2D facies map that are the same as the color or a color in the group.

In one or more embodiments, a grouping module (206) includes functionality to group the extracted objects (216) into an object group. Specifically, an object group is a collection of two or more objects (216). By grouping objects into an object group, the object group may be edited or otherwise manipulated as if the objects (216) in the object group were a single object.

The editing module (208) includes functionality to change and add facies characteristics to the object group. For example, the edits may include rotating the object group, expanding or contracting the object group in a particular direction, adding depth to the object group, adding additional objects from one or more additional facies maps to the object group, changing the azimuth, dip, and/or center of the object group, and performing other actions. In one or more embodiments, the editing of the object group creates a 3D compound model for the object group.

A 3D compound model is a model of a particular section of the geographic region. The boundaries of the particular section are defined by the edited 3D object group. Specifically, a 3D compound model includes a depth (i.e., information about a subsurface) for each object, facies characteristics of the objects, and boundaries of the objects. Thus, the 3D compound model may include the lithology of the surface, and information about the subsurface as well in one or more embodiments.

The model integration module (210) includes functionality to integrate the 3D compound model into the geological model. Specifically, the model integration module (210) includes functionality to incorporate the 3D compound model as a training image or directly into the geological model.

Continuing with FIG. 2, the user interface (212) corresponds to a mechanism for the user to interact with the computing system. Specifically, the user interface (212) may include input fields, buttons, drop-down boxes, and/or other user interface components to interact with the user. In one or more embodiments, the user interface (212) includes an editor interface (220) and a display window (222). The editor interface (220) includes functionality to receive editing commands from the user. The display window (222) includes functionality to display the 2D facies map, the extracted objects, and the object group during extraction, grouping, and editing. In one or more embodiments, the display window (222) may further include functionality to display the geological model (218). In one or more embodiments, the display window (222) may further include functionality to receive user edits, selections, and commands.

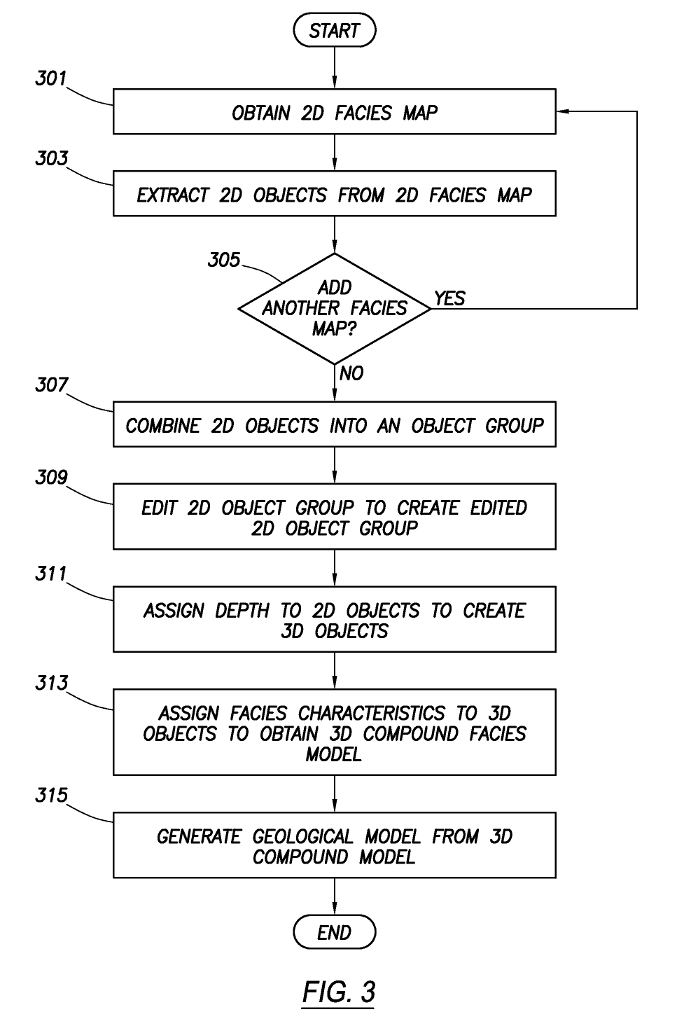

FIGS. 3-5 show flowcharts in one or more embodiments. While the various blocks in this flowchart are presented and described sequentially, one of ordinary skill, having benefit of this disclosure, will appreciate that at least a portion of the blocks may be executed in different orders, may be combined or omitted, and at least a portion of the blocks may be executed in parallel. Furthermore, the blocks may be performed actively or passively. For example, some blocks may be performed using polling or be interrupt driven in accordance with one or more embodiments. By way of an example, determination blocks may not require a processor to process an instruction unless an interrupt is received to signify that condition exists in accordance with one or more embodiments. As another example, determination blocks may be performed by performing a test, such as checking a data value to test whether the value is consistent with the tested condition in accordance with one or more embodiments.

FIG. 3 shows a flowchart for generating a 3D image for a geological model in one or more embodiments. In 301, a 2D facies map is obtained. In one or more embodiments, the 2D facies map is specified by the user. For example, a user may submit a file location of a file having the 2D facies map to the user interface. The system may access the file location to obtain and open the file. By way of another example, the user may select and copy at least a portion of an image corresponding to the 2D facies map from another open file into the user interface. By way of another example, the model generator may be configured with network file locations of 2D facies maps. In such an example, the user may select the geographic region and type of map. Based on the selection, the model generator may obtain the 2D facies map corresponding to the geographic region and type from a network file location.

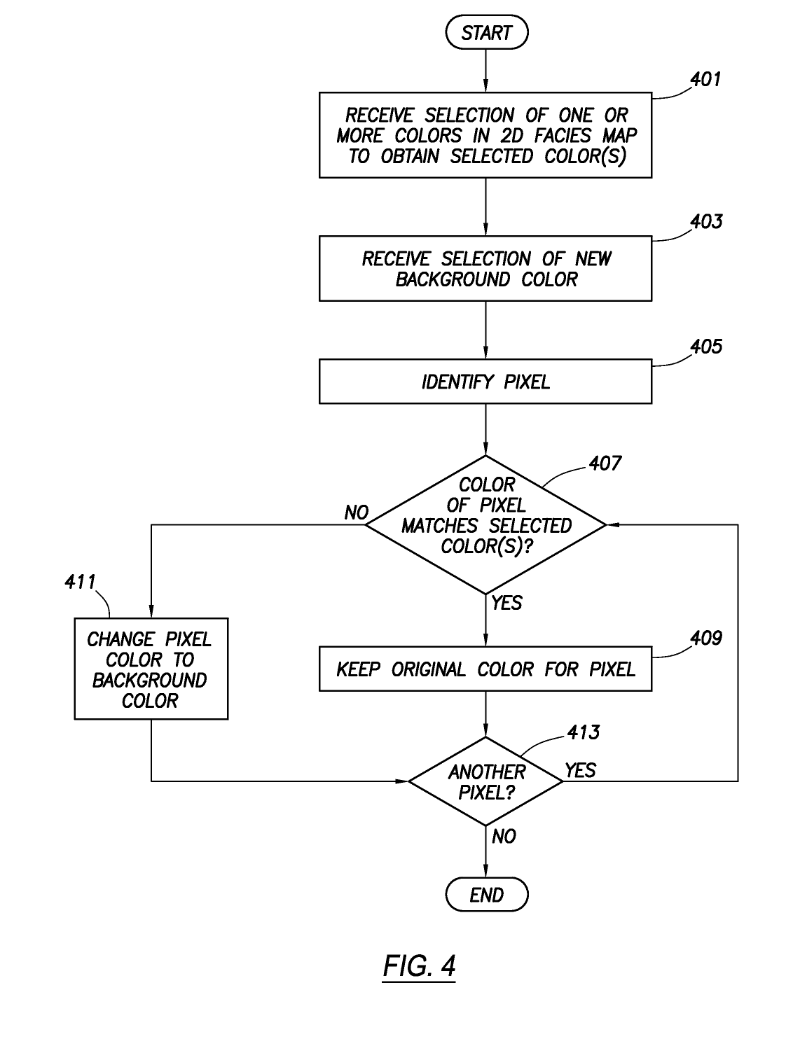

In 303, 2D objects are extracted from the 2D facies map. Extracting the 2D objects is shown in FIG. 4. Specifically, as shown in FIG. 4, in 401, a selection of one or more colors in the 2D facies map is received to obtain selected color(s). In one or more embodiments, using the user interface, the user may select portions (e.g., one or more pixels) of the 2D facies map that have the color(s) of facies which the user desires to extract. Further, the user may select colors from a color bar in the editor interface.

In 403, a selection of a new background color is received in one or more embodiments. In one or more embodiments, the user may select the background color or the background color may be automatically selected. The user may select the background color in a manner similar to the selecting the colors in 401. By way of another example, the model generator may automatically select the background color so as to not match any of the user-selected colors. In particular, the background color is a single color that does not match a selected color. For example, if the selected colors are brown and green, the background color may be orange.

In 405, a pixel is identified. In one or more embodiments, the model generator systematically iterates through pixels of the 2D facies map. In such embodiments, the first pixel identified may be the first pixel of the 2D facies map.

In 407, a determination is made whether the color of the pixel (i.e., pixel color) matches a selected color. The colors match if the colors are the same. If the color of the pixel matches the selected color, then the original color of the pixel is kept in 409. If the color of the pixel does not match the selected color, then the pixel color is changed to the background color. In 413, a determination is made whether another unprocessed pixel exists. If an unprocessed pixel exists, the method repeats with Block 405 for the next pixel. If an unprocessed pixel does not exist, then the 2D facies map includes just the selected color(s) and the background color.

In one or more embodiments, each selected color corresponds to a distinct object. In such embodiments, as a pixel is found that matches one of the selected colors, the pixel is added to the object corresponding to the color of the pixel. In one or more embodiments, extracting objects may further include removing the pixels in the image corresponding to the background color. Further, the extracted objects may be overlaid onto a grid. The dimensions of the grid may be by default, based on data extracted from the 2D facies map, metadata about the 2D facies map, or user selected.

Returning to FIG. 3, in 305, a determination is made whether to add another 2D facies map. If the determination is made to add another 2D facies map, then the flow may repeat with 301 to obtain objects from the next 2D facies map. In one or more embodiments, when another 2D facies map is used, the extracted objects from the next map may be added to the extracted objects from the first map. The configuration and placement of the new objects with respect to the existing objects may be defined by a user. For example, the user may select and move the new objects as a group to the existing objects. Further, in one or more embodiments, the model generator, with or without user input, may resize, rotate, or perform other actions to match the spatial dimensions of the new objects to the existing objects.

In 307, 2D objects are combined into an object group. Specifically, the grouping allows the model generator to treat the 2D objects as a single object. Although FIG. 3 shows grouping the 2D objects after objects are extracted, the 2D objects may be grouped during the extraction, after extracting from each 2D facies map, or at a different time. Further, although 2D objects are grouped, each object may be selected and individually manipulated in one or more embodiments.

In 309, the 2D objects in the object group are edited to create an edited 2D object group. In one or more embodiments, the editing adjusts for spatial distribution of the 2D objects. For example, the model generator may edit the 2D objects to change the size, orientation, position, shear, delete one or more portions, manually add one or more portions, or perform other editing actions. The object group may be edited as a single object and/or individual objects or subgroups of objects may be edited individually. In one or more embodiments, the user specifies the edits using the display window and the editor interface.

In 311, at least one depth is assigned to the 2D objects to create 3D objects. Specifically, a thickness allocation is assigned to the 2D objects. In one or more embodiments, the thickness is the subsurface (i.e., area beneath the surface of the earth) depth for each of the objects. In one or more embodiments, the depth may be square or another shape. Specifically, specifying the depth may include specifying a cross section shape. The cross section shape is a shape defined by the depth and a line at the surface. Example cross section shapes may be rectangle, half circle, half ellipsoid, wedge, and other cross section shapes. In one or more embodiments, depth may be separately assigned to particular objects, the object group as a whole, or a subgroup.

Assigning the depth may be performed automatically and/or by a user. For example, a geologist with knowledge of an area may assign a depth to the 2D objects. The depth may be assigned automatically based on sensor data gather from the field. For example, from the sensor data transmitted to the computing system, the model generator may identify the thickness and shape of various facies. Based on the dimensions and location of the facies and the 2D objects, the model generator may match the facies with the corresponding 2D objects. Thus, the 2D objects may be updated with the thickness and shape. A user may assist in defining the depth by editing and/or confirming the thickness assigned by the model generator using sensor data.

In 313, facies characteristics are assigned to the 3D objects to obtain a 3D compound model. Assigning the facies characteristics may be performed in a manner similar to assigning a depth to the 2D objects. Specifically, facies characteristics may be assigned by the user and/or automatically using sensor data collected from the field. In one or more embodiments, when facies characteristics are assigned by the user, the user interface may have separate input fields or other user interface component for each type of facies characteristic. For example, the user may specify the type of facies, porosity, and other characteristics from drop down boxes. Further, in one or more embodiments, the user may select each object individually to assign a particular facies characteristic to the object. When facies characteristics are assigned to the 3D objects, then the object group is a 3D compound model.

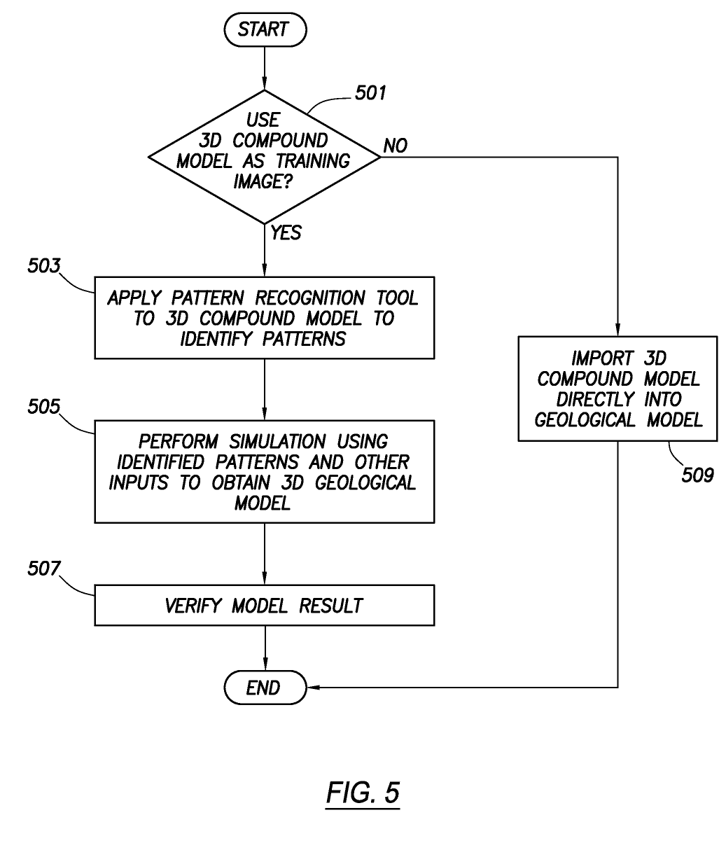

In 315, a geological model is generated from the 3D compound model. FIG. 5 shows a flowchart for generating a geological model from the 3D compound model. In 501, a determination is made whether to use the 3D compound model as a training image. Specifically, in one or more embodiments, the 3D compound model may be directly into the geological model or as a training image with other input to create a geological model.

One method of using a 3D compound model as a training image is presented in Tetzlaff, et al., “Application of Multipoint Geostatistics to Honor Multiple Attribute Constraints Applied to a Deepwater Outcrop Analog, Tanqua Karoo Basin, South Africa,” SEG Houston Annual Meeting (2005), which is hereby incorporated by reference.

A brief overview of a method for using the 3D compound model as a training image is presented below and in FIG. 5. In 503, a pattern recognition tool is applied to the 3D compound model to identify patterns. Specifically, the pattern recognition analyzes the 3D compound model and extracts patterns within the 3D compound model so that the patterns may be used as constraints while statistically modeling the facies.

In 505, simulation is performed using the identified patterns and other inputs to obtain a 3D geological model. Specifically, the pattern and its representative facies proportions are taken as inputs along with additional constraints from reservoir such as density map, up-scaled logs, orientation map, spatial regions etc. The simulation may be performed using reservoir grids and the above-mentioned inputs to form the full 3D reservoir model.

In 507, the model result is verified. The verification may include comparing the 3D geological model with well data and various statistical uncertainty analyses to ensure that the model complies with characteristics and requirements of the well data.

Although the above presents a method for using the 3D compound model as a training image, other methods for using the 3D compound model as a training image, that may or may not be based on statistics, may be used.

Rather than using the 3D compound model as a training image, the 3D compound model may be incorporated directed into the geological model in 509. Specifically, the geological model may be directed updated with the position and characteristics of the facies represented by the objects in the 3D compound model.

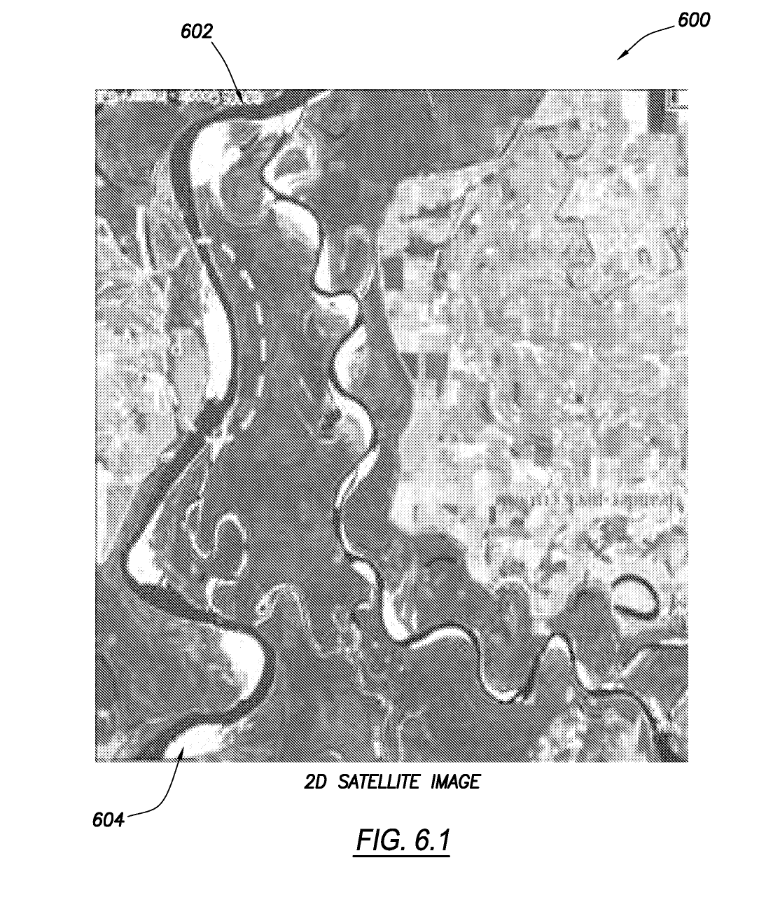

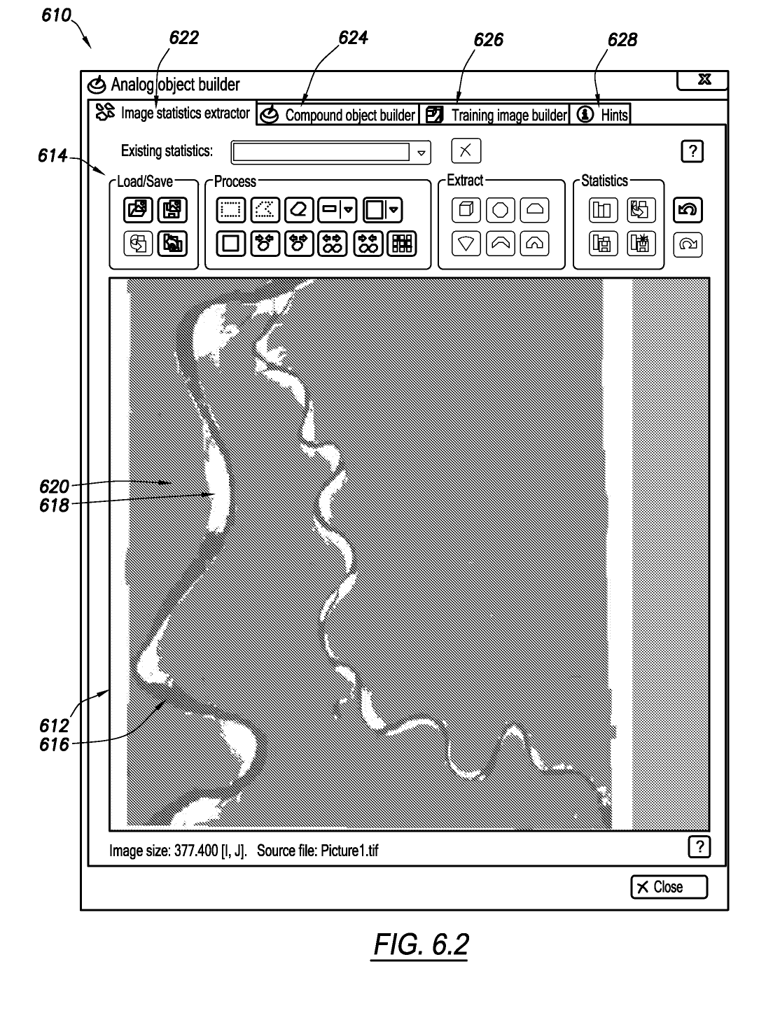

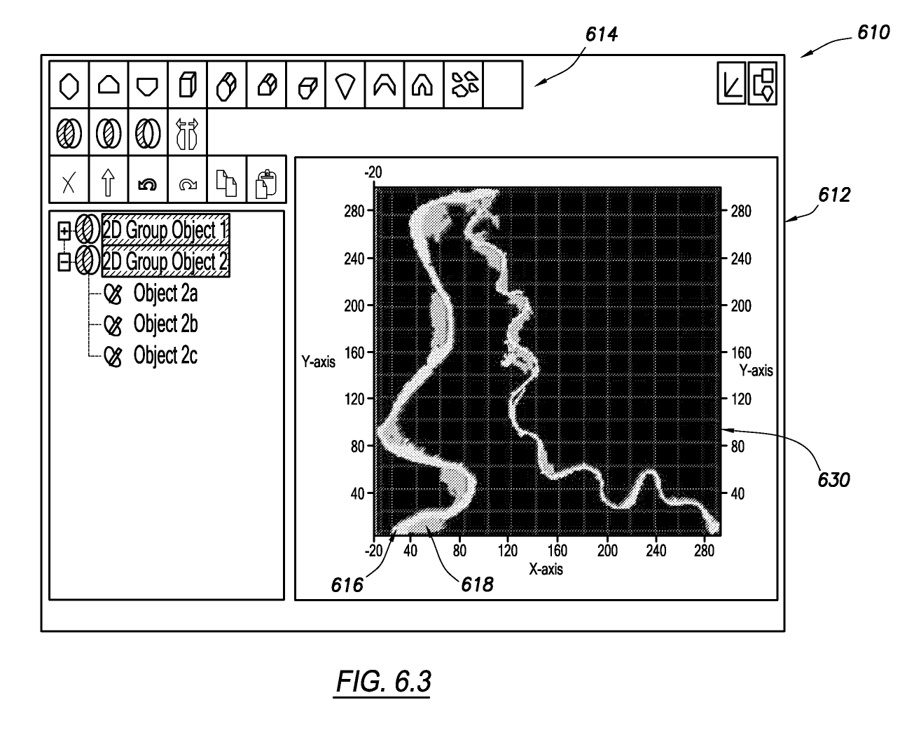

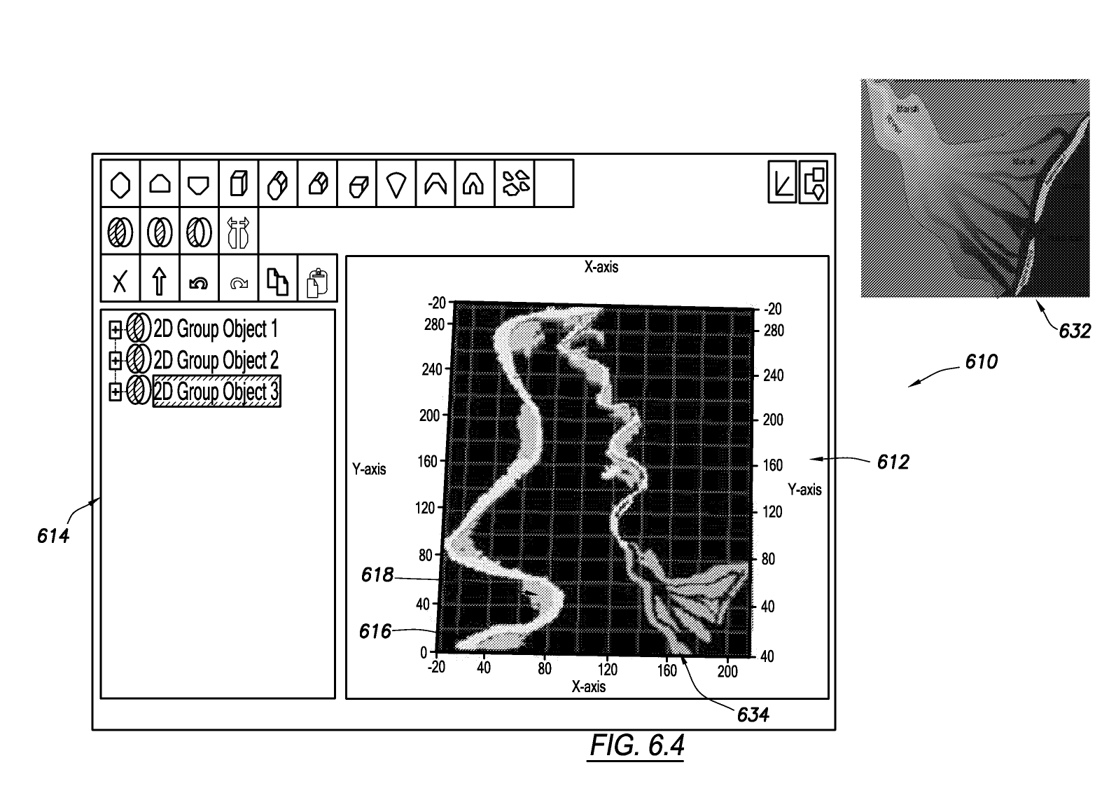

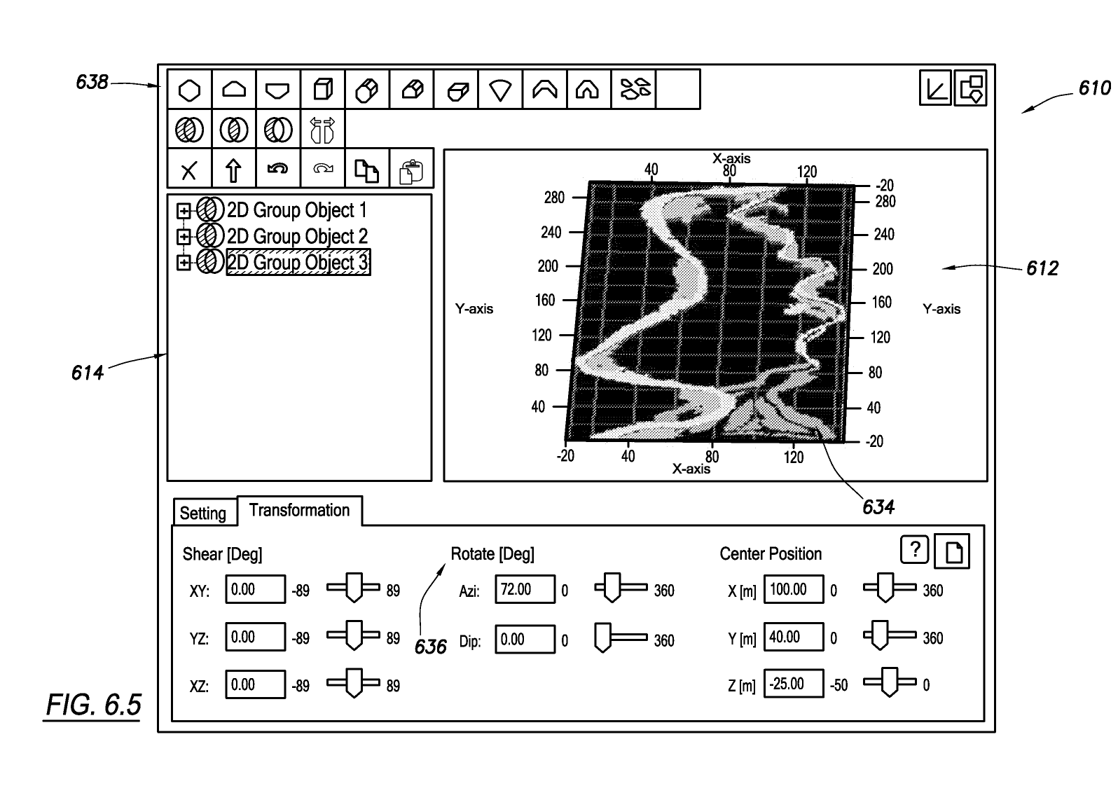

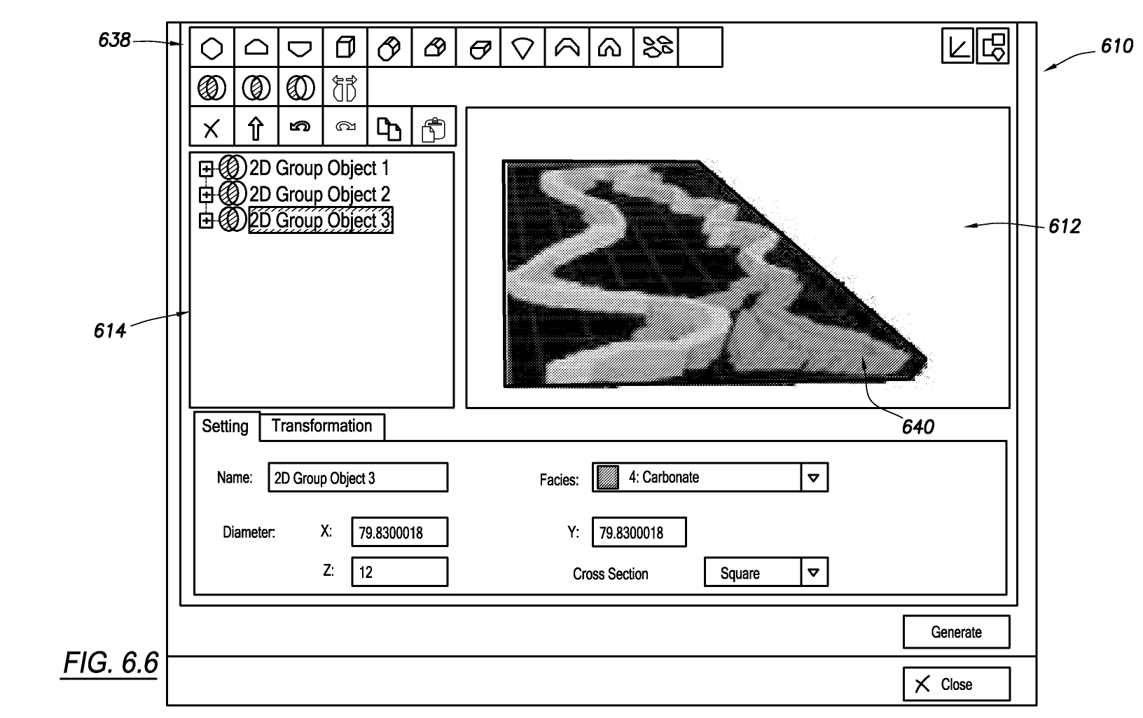

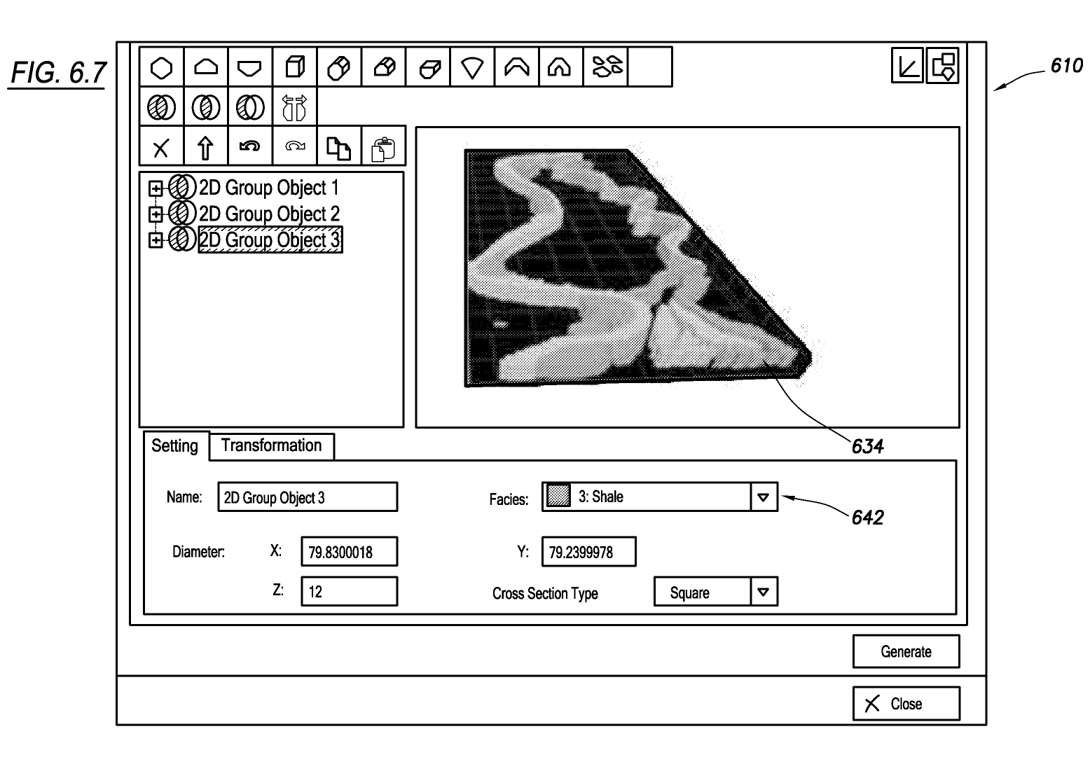

FIGS. 6.1-6.7 show an example in one or more embodiments. In the discussion below, various elements of the FIGs. are referenced by colors. In a grayscale version of the FIGs., the different colors are different shades of grey and same colors are the same shade of grey. The following example is for explanatory purposes and not intended to limit the scope of the claims. In the following example, consider the scenario in which a user would like to incorporate the path of a river and position of the corresponding banks into a geological model. In the example, because the user cannot accurately hand-draw the river and the corresponding banks, the user selects a satellite image that shows the river and corresponding banks.

FIG. 6.1 shows a schematic diagram of a satellite image (600) that the user selects showing the river (602) and corresponding river banks (604). As shown in FIG. 6.1, the river is shown as blue and the banks are shown as white. The satellite image also shows vegetation in various shades of green and desert in various shades of brown. The user selects the particular satellite image based on the satellite image showing the winding path of the river (602) and the relative positions of the riverbanks (604). In order to incorporate the river and riverbanks into the 3D geological model, the user requests that the model generator extracts the objects corresponding to the river (602) and riverbanks (604) from the satellite image based on the blue color and white color of the river (602) and riverbanks (604), respectively.

FIG. 6.4 shows a user interface (610) with a display window (612) and editor interface (614). In the display window (612), the river corresponds to object X (616) and the riverbank corresponds to object Y (618). Based on the color selection and the extraction blocks, the remaining portions are set as a green background color (620).

Continuing with FIG. 6.2, the editing interface (614) includes an extractor tab (622), a builder tab (624), a training tab (626), and a help tab (628). The interface components (e.g., load/save buttons, process buttons, extract buttons, and statistics buttons in FIG. 6.1) in the extractor tab may be used to extract objects from the 2D facies map. Specifically, a user may select the load/save buttons to load a 2D facies map into the model generator and save revisions and objects. The user may select the process buttons to specify changes to make during the extraction process, such as to remove particular portions of the objects corresponding to other rivers. The user may select the extract buttons to define which input objects to extract. Further, the user may select the statistics buttons to obtain information about percentages of the image that is extracted. By selecting the builder tab (624), the user may make edits to build a 3D compound model. By selecting the training tab (626), the user may specify parameters for incorporating the 3D compound model into the 3D geological model. The user may select the help tab (628) to obtain hints and help.

Continuing with the example, after the river and riverbanks are separately defined as objects from the remaining portion of the satellite image using the background color, pixels corresponding to the background color are removed and the remaining objects are placed on a grid.

FIG. 6.3 shows an example user interface (610) showing the editing interface (614) and display window (612) of an example builder tab. As shown in the display window, object X (616) and object Y (618) are overlaid on a grid (613). Object X (616) may be grouped with object Y to create an object group. By grouping the objects, the relative positions of the objects remain the same through the various edits.

Next, in the example, consider the scenario in which the user also wants to include, in the 3D geological model, information about a marsh caused by and located at the river delta. Because of the quality of the satellite image, the satellite image does not show the marsh. FIG. 6.4 shows an example of how the user may add the marsh. Specifically, the user identifies graphical computerized diagram (632) having the marsh at the river delta. The marsh is extracted using a similar method as discussed above and added to the existing object group. Thus, object Z (634) corresponding to the marsh is displayed on the grid (630) in the display window (612) with object X (616) and object Y (618).

Continuing with the example, FIG. 6.5 shows editing of the object group and individual objects. As shown in the display window (612) of FIG. 6.5, using the editing interface (614), the user may select to rotate object Z (634) with respect to the remaining objects by changing the azimuth and/or dip in the rotate section (636) of the editing interface (614). In other words, the objects may be edited as a single object using the object group or as independent objects. The user may perform additional edits through the model generator, such as for size, orientation, position, shear, to delete portions, and perform other actions. Additionally, if required, some of the objects may be manually created and associated using the provided parametric shapes (638). The objects may be re-grouped or ungrouped to perform the edits. Through the editing interface (614), the user may adjust for the spatial distribution of the objects.

Further, a depth may be assigned to the objects. FIG. 6.6 shows the user interface (610) for adding depth to the objects. Specifically, each of the 2D objects may be assigned with vertical thickness values based on well data in the targeted reservoir or from the empirical relationships from outcrop studies. The assignment of depth creates 3D objects (640) from the 2D objects as shown in display window (612). Further, using the parametric shapes (638), a user may specify the cross section shape types such as rectangle, half circle, half ellipsoid, wedge etc., based on the characteristics shapes of the geo-bodies.

As shown in FIG. 6.7, facies characteristics may be assigned to the objects using user interface (610). In the example, using the facies characteristic drop down menu (642), shale is assigned to object Z (634). By assigning a facies characteristic to the objects, 3D compound facies model is generated that has the characteristics of a miniature 3D analogue of the targeted reservoir. Thus, the user may export and use the 3D compound model shown in FIG. 6.7 to build the 3D geological model. As shown by way of the example, using the model generator, the user may incorporate facies information from a 2D facies map to generate a 3D geological model without having to manually draft the particular elements from the map.

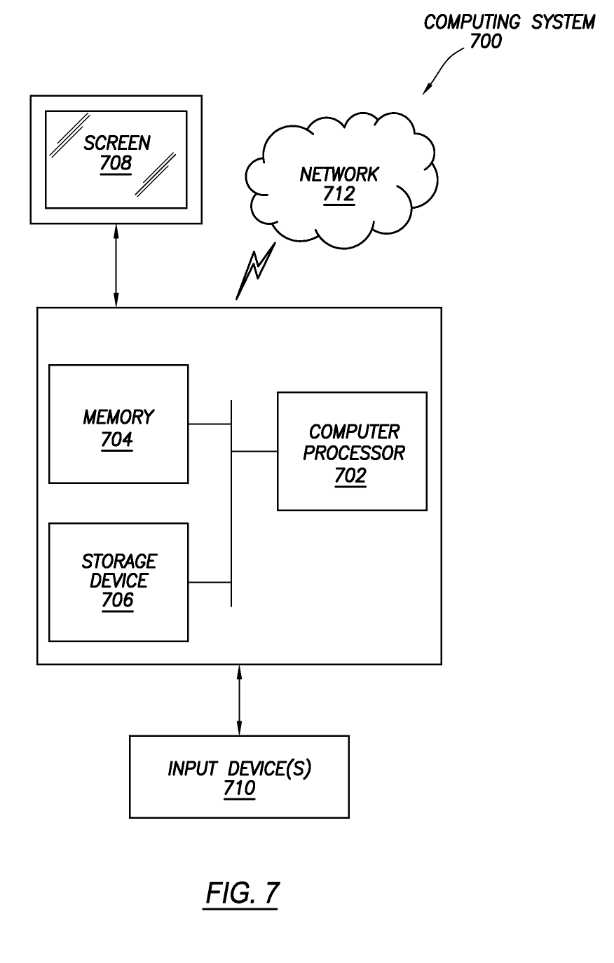

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 7, the computing system (700) may include one or more computer processor(s) (702), associated memory (704) (e.g., random access memory (RAM), cache memory, flash memory, etc.), one or more storage device(s) (706) (e.g., a hard disk, an optical drive such as a compact disk (CD) drive or digital versatile disk (DVD) drive, a flash memory stick, etc.), and numerous other elements and functionalities. The computer processor(s) (702) may be an integrated circuit for processing instructions. For example, the computer processor(s) may be one or more cores, or micro-cores of a processor. The computing system (700) may also include an input device (710), such as a touchscreen, keyboard, mouse, microphone, touchpad, electronic pen, or any other type of input device. Further, the computing system (700) may include one or more output device(s) (708), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (700) may be connected to a network (714) (e.g., a local area network (LAN), a wide area network (WAN) such as the Internet, mobile network, or any other type of network) via a network interface connection (not shown). The input and output device(s) may be locally or remotely (e.g., via the network (712)) connected to the computer processor(s) (702), memory (704), and storage device(s) (706). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (700) may be located at a remote location and connected to the other elements over a network (714). Further, embodiments may be implemented on a distributed system having a plurality of nodes, where each portion may be located on a different node within the distributed system. In one or more embodiments, the node corresponds to a distinct computing device. The node may correspond to a computer processor with associated physical memory. The node may correspond to a computer processor or micro-core of a computer processor with shared memory and/or resources.

Although only a few example embodiments have been described in detail above, those skilled in the art will readily appreciate that many modifications are possible in the example embodiments without materially departing from the scope of the claims. Accordingly, all such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for generating a three dimensional (3D) compound model for geological modeling, comprising:
receiving a first two dimensional (2D) facies map (214) of the surface of a geographic region;
extracting a first plurality of 2D objects (216) from the first 2D facies map (214);
combining the first plurality of 2D objects (216) into an object group;
editing the 2D object group to adjust for spatial distribution in 3D space to obtain edited 2D object group;
assigning a depth to the edited 2D object group to obtain a 3D object group;
assigning a facies characteristic to the 3D object group to obtain the 3D compound model; and
storing the 3D compound model.

2. The method of claim 1, further comprising:
generating a geological model (218) from the 3D compound model.

3. The method of claim 1, wherein the first 2D facies map is a satellite image.

4. The method of claim 3, further comprising:
receiving a second 2D facies map, wherein the second 2D facies map comprises a diagram of the geographic region; and
extracting a second plurality of objects from the second 2D facies map,
wherein the second plurality of objects are combined with the first plurality of objects into the object group.

5. The method of claim 4, wherein combining the second plurality of objects into the object group comprises rotating and resizing the second plurality of objects to match the first plurality of objects.

6. The method of claim 1, wherein extracting the first plurality of 2D objects comprises:
receiving a plurality of colors matching the first plurality of 2D objects; and
setting, to a background color, each of a plurality of pixels of the first 2D facies map that do not match at least one of the plurality of colors.

7. The method of claim 6, wherein combining the first plurality of 2D objects into the object group comprises:
after setting to the background color, assigning, to the object group, each of a plurality of pixels of the first 2D facies map that do not match the background color; and
plotting the plurality of pixels assigned to the object group onto a grid.

8. The method of claim 1, wherein editing comprises:
receiving a modification request comprising a modification of at least one selected from a group consisting of size, orientation, position, and shear of the object group; and
performing the modification in accordance with the modification request.

9. The method of claim 1, wherein assigning the facies characteristics comprises assigning a type of rock and a porosity to each portion of the 3D object group.

10. A system for generating a three dimensional (3D) compound model for geological modeling comprising:
a computer processor (702);
an extraction module (204) executing on the computer processor (702) and configured to:
extract a plurality of 2D objects (216) from a two dimensional (2D) facies map (214) of a surface of a geographic region;
a grouping module (206) executing on the computer processor (702) and configured to:
combine the plurality of 2D objects (216) into an object group; and
an editing module (208) executing on the computer processor (702) and configured to:
edit the 2D object group to adjust for spatial distribution in 3D space to obtain edited 2D object group,
assign a depth to the edited 2D object group to obtain a 3D object group;
assign a facies characteristic to the 3D object group to obtain the 3D compound model, and
store the 3D compound model.

11. The system of claim 10, further comprising:
a model integration module (210) configured to generate a geological model (218) using the 3D compound model.

12. The system of claim 10, further comprising:
a data repository (202) for storing the plurality of objects (216) the 2D facies map.

13. The system of claim 10, further comprising:
a user interface (212) comprising:
an editor interface (220) for editing the 2D object group, and
a display window (222) for displaying the 2D object group.

14. (canceled)
